(19) United States
(12) Patent Application Publication
(10) Pub. No.: US 2022/0041962 A1
(43) Pub. Date: Feb. 10, 2022

(54) SHAPED BODY COMPRISING A POLYETHYLENE GLYCOL GRAFT COPOLYMER AND THE AROMA CHEMICAL

(71) Applicant: BASF SE, Ludwigshafen am Rhein (DE)

(72) Inventors: Bernd Dieter OSCHMANN, Ludwigshafen am Rhein (DE); Stephan HUEFFER, Ludwigshafen am Rhein (DE); Wolfgang KRAUSE, Lampertheim (DE)

(21) Appl. No.: 17/414,684

(22) PCT Filed: Dec. 13, 2019
(86) PCT No.: PCT/EP2019/085003

§ 371 Date: Jun. 16, 2021

(30) Foreign Application Priority Data
Dec. 19, 2018 (EP) 18213807.3

(51) Int. Cl. C11D 11/00; C11D 3/37; C11D 3/50

(52) U.S. Cl. CPC C11D 11/0082; C11D 3/3788; C11D 11/0017; C11D 3/505; C11D 3/3707

(57) ABSTRACT

The presently claimed invention relates to a shaped body comprising at least one graft copolymer (I) comprising a polyether and one or more side chains obtained by the polymerization of compounds of formula (IA) and/or formula (IB) and/or formula (IC); CH₂—CY—C(=0)-0R₁ formula (IA) CH₂—CY-0-C(=0)-R₁ formula (IB) CH₂—CH—CH₂—O—C(═O)—R₁ formula (IC) wherein R₁ is in each case selected from C₄-C₂₀-alkyl or C₄-C₂₀-alkenyl and Y is in each case selected from hydrogen and methyl, and at least one aroma chemical. The presently claimed invention is also directed towards a process for the preparation of the shaped body. The presently claimed invention also relates to a composition comprising at least one shaped body.

### FIELD OF THE INVENTION

The presently claimed invention relates to a shaped body comprising at least one graft copolymer (I) comprising a polyether and one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl, and at least one aroma chemical.

Furthermore, the presently claimed invention is directed towards a process for the preparation of the shaped body. The presently claimed invention also relates to a composition comprising at least one shaped body.

### BACKGROUND OF THE INVENTION

Many consumers like to enhance the scent of their laundry using various products such as scented detergents, fabric softeners and additives to the wash. In the fabric detergent composition application, it is desirable to enhance the consumer experience by releasing scent at different consumer contact points such as the point of purchase, the opening the door of a dryer, the point of storing laundry, and the point of wearing clothes. Nowadays, more and more consumers prefer a long-lasting scent on their laundry even days after the washing.

U.S. Pat. No. 9,453,188 describes a fabric treatment composition having a plurality of pastilles comprising of a polyethylene glycol, a balancing agent and friable perfume microcapsule.

U.S. Pat. No. 9,347,022 describes a fabric treatment composition having a plurality of particles comprising a polyethylene glycol, perfume and starch granules. The starch granules have a starch perfume load level of the perfume.

U.S. Pat. No. 9,453,189 relates to a fabric treatment composition having a plurality of pastilles comprising a polyethylene glycol, free perfume and friable perfume microcapsule.

The current state of art laundry scent additives for detergents and fabric softeners cannot provide long-lasting, strong to intermediate scent at the stage of storing and wearing clothing due to their fragrance load limitation and loss of fragrance during washing and drying because the laundry scent additives get rapidly dispersed and diluted during laundering in the aqueous wash solution along with the water-soluble components of the detergent composition. Consequently, only a relatively minor amount of perfume is available to contact and adhere to the fabric being laundered. The major portion of the perfume is drained from the washing machine with the wash solution during the wash cycle.

Moreover, to the extent that some perfume is still in contact with the fabric after the washing cycle, it tends to be dissipated subsequently during drying, such as, electric drying in which the washed fabrics are tumbled rapidly at relatively high temperature. As a result of the aforementioned problems, fabric laundered with conventional detergent compositions generally retain only a faint fragrance which has no particular aesthetic appeal to the user.

Thus, the object of the presently claimed invention is to provide a shaped body aroma booster which retains an aroma chemical for a prolonged period and is used as part of a laundry detergent.

### SUMMARY OF THE INVENTION

It was surprisingly found that shaped bodies comprising a graft copolymer (I) retain a high amount of an aroma chemical for a prolong period such as for example 12 weeks and, hence, impart an enhanced aroma retention to laundered fabrics.

Hence, the presently claimed invention is directed, in one aspect, to a shaped body comprising

a) at least one graft copolymer (I) comprising
i) a polyether and
ii) one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl, and

b) at least one aroma chemical.

In another aspect, the presently claimed invention is directed towards a composition comprising at least one shaped body.

In yet another aspect, the presently claimed invention relates to a process for the preparation of the shaped body.

### DETAILED DESCRIPTION OF THE INVENTION

The following detailed description is merely exemplary in nature and is not intended to limit the presently claimed invention or the application and uses of the presently claimed invention. Furthermore, there is no intention to be bound by any theory presented in the preceding technical field, background, summary or the following detailed description.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the subject matter described herein are capable of operation in other sequences than described or illustrated herein. In case the terms “(A)”, “(B)” and “(C)” or “(a)”, “(b)”, “(c)”, “(d)”, “(i)”, “(ii)” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the subject matter are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” or “preferred embodiment” means that a particular feature, structure or characteristic described in connection with the embodiment is included in at least one embodiment of the presently claimed invention. Thus, appearances of the phrases “in one embodiment” or “In a preferred embodiment” or “in a preferred embodiment” in various places throughout this specification are not necessarily all referring to the same embodiment but may refer. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the subject matter, and form different embodiments, as would be understood by those in the art. For example, in the appended claims, any of the claimed embodiments are used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

Graft Copolymer (I)

An aspect of the presently claimed invention is directed to a shaped body comprising

a) at least one graft copolymer (I) comprising
i) a polyether and
ii) one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl, and

b) at least one aroma chemical.

In one embodiment, the at least one graft copolymer (I) comprises a polyether and one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl.

In the context of the presently claimed invention, the polyether bears at least 5 ether groups per mole and—if at all—only hydroxyl groups, for example one, two or three hydroxyl groups per molecule. In a preferred embodiment, the hydroxyl groups are primary or secondary hydroxyl groups. In more preferred embodiment, the hydroxyl groups are primary hydroxyl groups. In a preferred embodiment, the polyether is referred to as polyether polyol, and have the terminal hydroxyl groups.

In a preferred embodiment, the polyether is selected from the group consisting of polyethylene glycol, polypropylene glycol and ethylene oxide-propylene oxide block copolymer.

In a preferred embodiment, the polyether is polyethylene glycol with a number average molecular weight Mₙ in the range of ≥500 to ≤100,000 g/mol. In a more preferred embodiment, polyethylene glycol with a number average molecular weight Mₙ in the range of ≥1,000 to ≤25,000 g/mol and, in an even more preferred embodiment, polyethylene glycol with a number average molecular weight Mₙ in the range of ≥4,000 to ≤9,500 g/mol.

In a preferred embodiment, the polyether is polypropylene glycol with an average molecular weight Mₙ in the range of ≥500 to ≤20,000 g/mole. In more preferred embodiment, polypropylene glycol with an average molecular weight Mₙ in the range of ≥2,000 to ≤10,000 g/mole and in an even more preferred embodiment, polypropylene glycol with an average molecular weight Mₙ in the range of ≥4,000 to ≤9,000 g/mol.

A further example is polytetrahydrofuran, also referred to as poly-THF. In a preferred embodiment, the polyether is poly-tetrahydrofuran with a number average molecular weight Mₙ in the range of ≥500 to ≤5,000 g/mol.

A further example of polyether is a copolymer of ethylene glycol and propylene glycol, for example a random copolymer and preferably a block copolymer, for example di-block copolymer and tri-block copolymer.

Polyethers are preferably capped or non-capped. In a more preferred embodiment, the polyether is capped with C₁-C₂₀-alkyl or C₆-C₂₀-2-hydroxyalkyl. In an even more preferred embodiment, the polyether is capped with C₁-C₄-alkyl or C₆-C₂₀-2-hydroxyalkyl. Examples of C₃-C₂₀-alkyl are methyl, ethyl, n-propyl, isopropyl, n-butyl, isobutyl, sec-butyl, tertbutyl, n-pentyl, isopentyl, sec-pentyl, neopentyl, 1,2-dimethylpropyl, isoamyl, n-hexyl, isohexyl, sec-hexyl, n-heptyl, n-octyl, 2-ethyl hexyl, n-nonyl, n-decyl or isodecyl, n-C₁₂H₂₅, n-C₁₄H₂₉, n-C₁₆H₃₃ or n-C₁₈H₃₇, preferred are C₁-C₄-alkyl, for example methyl, ethyl, n-propyl, n-butyl, and in particular methyl. Examples of C₆₋C₂₀-2-hydroxyalkyl are 2-hydroxy-n-hexyl, 2-hydroxy-n-octyl, 2-hydroxy-n-decyl, 2-hydroxy-n-dodecyl, 2-hydroxy-n-tetradecyl, 2-hydroxy-n-hexadecyl, 2-hydroxy-n-octadecyl, and 2-hydroxy-n-eicosyl.

In a preferred embodiment, R₁ is selected from the group consisting of n-hexyl, isohexyl, sec-hexyl, n-heptyl, n-octyl, 2-ethyl hexyl, n-nonyl, n-decyl or isodecyl, n-dodecyl, n-C₁₂H₂₅, n-C₁₄H₂₉, n-C₁₆H₃₃, n-C₁₈H₃₇, n-hexenyl, isohexenyl, n-heptenyl, n-octenyl, n-decenyl and n-dodecenyl.

In a preferred embodiment, the compound of formula (IA) is selected from the group consisting of 2-ethylhexyl(meth)acrylate, 2-n-propylheptyl(meth)acrylate, stearyl(meth)acrylate, lauryl(meth)acrylate, lauryl acrylate, palmityl(meth)acrylate and myristyl(meth)acrylate. In a more preferred embodiment, the compound of formula (IA) is selected from the group consisting of 2-ethylhexylacrylate, lauryl(meth)acrylate, lauryl acrylate and stearyl(meth)acrylate.

In another preferred embodiment, the compound of the formula (IB) is selected from the group consisting of vinylbutyrate, vinyl-n-hexanoate, vinyl-n-octanoate, vinyl-2-ethylhexanoate, vinyllaurate, vinylstearate, vinylmyristate and vinylpalmitate.

In yet another preferred embodiment, the compound of the formula (IC) is selected from the group consisting of allylbutyrate, allyl-n-hexanoate, allyl-n-octanoate, allyl-2-ethylhexanoate, allyllaurate, allylstearate, allylmyristate and allylpalmitate.

In a preferred embodiment, the graft copolymer (I) has a number average molecular weight Mₙ in the range of ≥2,250 to ≤25,000 g/mol. In a preferred embodiment, the graft copolymer (I) of the shaped body has a number average molecular weight Mₙ in the range of ≥2,500 to ≤25,000 g/mol.

In a preferred embodiment of the presently claimed invention, the graft copolymer (I) has a broad weight distribution. A broad weight distribution in relation to the graft copolymer (I) means that such a copolymer (I) has a polydispersity Q=M_{w}/Mₙ in the range of ≥3.5 to ≤5.5.

In another embodiment of the presently claimed invention, the graft copolymer (I) has a narrow molecular weight distribution. A narrow molecular weight distribution in relation to the graft copolymer (I) means that such a copolymer (I) has a polydispersity Q=M_{w}/Mₙ in the range of ≥1.5 to ≤3.25

In a preferred embodiment of the presently claimed invention, the melting point of the graft copolymer (I) is in the range of from ≥30° C. to ≤70° C., in more preferred embodiment in the range of from ≥50° C. to ≤70° C.

In another preferred embodiment, the graft copolymer (I) has a weight ratio of the polyether to the side chains in the range of from 95:5 to 3:2.

In yet another preferred embodiment, the graft copolymer (I) is present in an amount in the range of ≥80.0% to ≤99.9% wt. %, based on the total weight of the shaped body.

Aroma Chemical

In the context of the presently claimed invention, “aroma chemical” is a generic term for natural or synthetic compounds having intrinsic odor or scent.

In the context of the presently claimed invention, “odor” or “scent” or “olfactory perception” is the interpretation of the sensory stimuli which are sent from the chemoreceptors in the nose or other olfactory organs to the brain of a living being. The odor can be a result of sensory perception by the nose of fragrances, which occurs during inhalation. In this case, the air serves as odor carrier.

In the context of the presently claimed invention, a “solvent for aroma chemical” serves as the diluent of the aroma chemical to be used according to the presently claimed invention or the composition according to the presently claimed invention, but without having any intrinsic odorous properties. Some solvents also have fixing properties.

In a preferred embodiment, the at least one aroma chemical or a mixture of several aroma chemicals is preferably admixed to 0.1 to 99 wt. % with a diluent or solvent. In a preferred embodiment, the at least one aroma chemical or a mixture of several aroma chemicals is present in a 40 wt. % solution with a diluent or solvent. In more preferred embodiment, at least 50 wt. % solution, even more preferred embodiment at least 60 wt. % solution, yet more preferred embodiment at least 70 wt. % solution, in particularly preferred embodiment at least 80 wt. % solution, and in yet more particularly preferred embodiment at least 90 wt. % solution.

In a preferred embodiment, the at least one aroma chemical or a mixture of several aroma chemicals is given in an olfactorily acceptable solution.

In a preferred embodiment, the olfactorily acceptable solvents are selected from the group consisting of ethanol, isopropanol, dipropylene glycol (DPG), 1,2-propylene glycol, 1,2-butylene glycol, glycerol, diethylene glycol monoethyl ether, diethyl phthalate (DEP), 1,2-cyclohexane dicarboxylic acid diisononyl ester, isopropyl myristate (IPM), triethyl citrate (TEC), benzyl benzoate (BB) and benzyl acetate. In this case, preference is given in turn to ethanol, diethyl phthalate, propylene glycol, dipropylene glycol, triethyl citrate, benzyl benzoate and isopropyl myristate.

In a preferred embodiment, the at least one aroma chemical is selected from the group consisting of hydrocarbons, aliphatic alcohols, aliphatic aldehydes and acetals thereof, aliphatic ketones and oximes thereof, aliphatic sulfur-containing compounds, aliphatic nitriles, esters of aliphatic carboxylic acids, acyclic terpene alcohols, acyclic terpenes and ketones, cyclic terpene alcohols, cyclic terpene aldehydes and ketones, cyclic alcohols, cycloaliphatic alcohols, cyclic and cycloaliphatic ethers, cyclic and macrocyclic ketones, cycloaliphatic aldehydes, cycloaliphatic ketones, esters of cyclic alcohols, esters of cycloaliphatic alcohols, ester of cycloaliphatic carboxylic acids, araliphatic alcohols, esters of araliphatic alcohols and aliphatic carboxylic acids, araliphatic ethers, aromatic and araliphatic aldehydes, aromatic and araliphatic ketones, aromatic and araliphatic carboxylic acids, nitrogen-containing compounds, phenols, heterocyclic compounds, lactones and essential oil or mixture thereof.

In a preferred embodiment, the presently claimed shaped body comprises the at least one aroma chemical, in a more preferred embodiment 2, 3, 4, 5, 6, 7, 8 or more aroma chemicals, which are for example selected from:

alpha-hexylcinnamaldehyde, 2-phenoxyethyl isobutyrate (Phenirat¹), dihydromyrcenol (2,6-dimethyl-7-octen-2-ol), methyl dihydrojasmonate (preferably having a cis-isomer content of more than 60 wt. %) (Hedione⁹, Hedione HC⁹), 4,6,6,7,8,8-hexamethyl-1,3,4,6,7,8-hexahydrocyclopenta[g]benzopyran (Galaxolide³), tetrahydrolinalool (3,7-dimethyloctan-3-ol), ethyl linalool, benzyl salicylate, 2-methyl-3-(4-tert-butylphenyl)propanal (Lilial²), cinnamyl alcohol, 4,7-methano-3a,4,5,6,7,7a-hexahydro-5-indenyl acetate and/or 4,7-methano-3a,4,5,6,7,7a-hexahydro-6-indenyl acetate (Herbaflorat¹), citronellol, citronellyl acetate, tetrahydrogeraniol, van-illin, linalyl acetate, styralyl acetate (1-phenylethyl acetate), octahydro-2,3,8,8-tetramethyl-2-acetonaphthone and/or 2-acetyl-1,2,3,4,6,7,8-octahydro-2,3,8,8-tetramethylnaphthalene (Iso E Super³), hexyl salicylate, 4-tert-butylcyclohexyl acetate (Oryclone¹), 2-tert-butylcyclohexyl acetate (Agrumex HC¹), alpha-ionone (4-(2,2,6-trimethyl-2-cyclohexen-1-yl)-3-buten-2-one), n-alpha-methylionone, alpha-isomethylionone, coumarin, terpinyl acetate, 2-phenylethyl alcohol, 4-(4-hydroxy-4-methylpentyl)-3-cyclohexenecarboxaldehyde (Lyral³), alpha-amylcinnamaldehyde, ethylene brassylate, (E)- and/or (Z)-3-methylcyclopentadec-5-enone (Muscenone⁹), 15-pentadec-11-enolide and/or 15-pentadec-12-enolide (Globalide¹), 15-cyclopentadecanolide (Macrolide¹), 1-(5,6,7,8-tetrahydro-3,5,5,6,8,8-hexamethyl-2-naphthalenyl)ethanone (Tonalide¹⁰), 2-isobutyl-4-methyltetrahydro-2H-pyran-4-ol (Florol⁹), 2-ethyl-4-(2,2,3-trimethyl-3-cyclopenten-1-yl)-2-buten-1-ol (Sandolene¹), cis-3-hexenyl acetate, trans-3-hexenyl acetate, trans-2-cis- -6-nonadienol, 2,4-dimethyl-3-cyclohexenecarboxaldehyde (Vertocitral¹), 2,4,4,7-tetramethyl-oct-6-en-3-one (Claritone¹), 2,6-dimethyl-5-hepten-1-al (Melonal²), borneol, 3-(3-isopropylphenyl)butanal (Florhydral²), 2-methyl-3-(3,4-methylenedioxyphenyl)propanal (Helional³), 3-(4-ethylphenyl)-2,2-dimethylpropanal (Florazon¹), 7-methyl-2H-1,5-benzodioxepin-3(4H)-one (Calonel9515), 3,3,5-trimethylcyclohexyl acetate (preferably with a content of cis-isomers of 70 wt. %) or more and 2,5,5-trimethyl-1,2,3,4,4a,5,6,7-octahydronaphthalen-2-ol (Ambrinol S¹). In the context of the presently claimed invention, the at least one aroma chemical mentioned above are accordingly preferably combined with mixtures according to the presently claimed invention.

If trade names are specified above, these refer to the following sources:

1 Trade name of Symrise GmbH, Germany;

2 Trade name of Givaudan AG, Switzerland;

3 Trade name of International Flavors & Fragrances Inc., USA;

5 Trade name of Danisco Seillans S.A., France;

9 Trade name of Firmenich S.A., Switzerland;

10 Trade name of PFW Aroma Chemicals B.V., The Netherlands.

Furthermore, the at least one aroma chemical with which the (E/Z)-cyclopentadecenylcarbaldehydes (I)-(III) is preferably combined, for example, to give a composition are found, for example, in S. Arctander, Perfume and Flavor Chemicals, Vol. I and II, Montclair, N.J., 1969, Author's edition or K. Bauer, D. Garbe and H. Surburg, Common Fragrance and Flavor Materials, 4th. Ed., Wiley-VCH, Wein-heim 2001. Specifically, the following are mentioned as preferred:

extracts from natural raw materials such as essential oils, concretes, absolutes, resins, resinoids, balsams, tinctures such as e.g.

ambra tincture; amyris oil; angelica seed oil; angelica root oil; anise oil; valerian oil; basil oil; tree moss absolute; bay oil; mugwort oil; benzoin resin; bergamot oil; beeswax absolute; birch tar oil; bitter almond oil; savory oil; bucco leaf oil; cabreuva oil; cade oil; calmus oil; camphor oil; cananga oil; cardamom oil; cascarilla oil; cassia oil; cassie absolute; castoreum absolute; cedar leaf oil; cedar wood oil; cistus oil; citronella oil; lemon oil; copaiba balsam; copaiba balsam oil; coriander oil; costus root oil; cumin oil; cypress oil; davana oil; dill oil; dill seed oil; eau de brouts absolute; oakmoss absolute; elemi oil; estragon oil; eucalyptus citriodora oil; eucalyptus oil; fen-nel oil; spruce needle oil; galbanum oil; galbanum resin; geranium oil; grapefruit oil; guaiac wood oil; gurjun balsam; gurjun balsam oil, helichrysum absolute; helichrysum oil; ginger oil; iris root absolute; iris root oil; jasmine absolute; calamus oil; camellia oil blue; camellia oil roman; carrot seed oil; cascarilla oil; pine needle oil; spearmint oil; cumin oil; labdanum oil; labdanum absolute; labdanum resin; lavandin absolute; lavandin oil; lavender absolute; lavender oil; lemon grass oil; lovage oil; lime oil distilled; lime oil pressed; linalool oil; litsea cubeba oil; laurel leaf oil; macis oil; marjoram oil; mandarin oil; massoia bark oil; mimosa absolute; musk seed oil; musk tincture; clary sage oil; nutmeg oil; myrrh absolute; myrrh oil; myrtle oil; clove leaf oil; clove flower oil; neroli oil; olibanum absolute; olibanum oil; opopanax oil; orange blossom absolute; orange oil; oregano oil; palmarosa oil; patchouli oil; perilla oil; Peruvian balsam oil; parsley leaf oil; parsley seed oil; petitgrain oil; peppermint oil; pepper oil; allspice oil; pine oil; poley oil; rose absolute; rosewood oil; rose oil; rosemary oil; sage oil dalmatian; sage oil Spanish; sandalwood oil; celery seed oil; spike lavender oil; star anis oil; styrax oil; tagetes oil; fir needle oil; tea tree oil; turpen-tine oil; thyme oil; tolu balsam; tonka absolute; tuberose absolute; vanilla extract; violet leaf abso-lute; verbena oil; vetiver oil; juniper berry oil; wine yeast oil; vermouth oil; wintergreen oil; ylang oil; ysop oil; civet absolute; cinnamon leaf oil; cinnamon bark oil; and fractions thereof or ingredients isolated therefrom;

the group of hydrocarbons, such as e.g. 3-carene; alpha-pinene; beta-pinene; alpha-terpinene; gamma-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;

the aliphatic alcohols such as e.g. hexanol; octanol; 3-octanol; 2,6-dimethylheptanol; 2-methyl-2-heptanol; 2-methyl-2-octanol; (E)-2-hexenol; (E)- and (Z)-3-hexenol; l-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;

the aliphatic aldehydes and acetals thereof such as e.g. hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethylacetal; 1,1-dimethoxy-2,2,5-trimethyl-4-hexene; citronellyloxyacetaldehyde; (E/Z)-1-(1-methoxypropoxy)-3-hexene; the ali-phatic ketones and oximes thereof such as e.g. 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;

the aliphatic sulfur-containing compounds such as e.g. 3-methylthiohexanol; 3-methylthiohexyl acetate; 3-mercaptohexanol; 3-mercaptohexyl acetate; 3-mercaptohexyl butyrate; 3-acetylthiohexyl acetate; l-menthene-8-thiol;

the aliphatic nitriles such as e.g. 2-nonenenitrile; 2-undecenenitrile; 2-tridecenenitrile; 3,12-tridecadienenitrile; 3,7-dimethyl-2,6-octadienenitrile; 3,7-dimethyl-6-octenenitrile;

the esters of aliphatic carboxylic acids such as e.g. (E)- and (Z)-3-hexenyl formate; ethyl aceto-acetate; isoamyl acetate; hexyl acetate; 3,5,5-trimethyl hexyl acetate; 3-methyl-2-butenyl acetate; (E)-2-hexenyl acetate; (E)- and (Z)-3-hexenyl acetate; octyl acetate; 3-octyl acetate; l-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl 2-methylpentanoate; ethyl hexanoate; allyl hexanoate; ethyl heptanoate; allyl heptanoate; ethyl octanoate; (E/Z)-ethyl-2,4-decadienoate; methyl 2-octinate; methyl 2-noninate; allyl 2-isoamyloxy acetate; methyl-3,7-dimethyl-2,6-octadienoate; 4-methyl-2-pentyl crotonate;

the acyclic terpene alcohols such as e.g. geraniol; nerol; linalool; lavandulol; nerolidol; farnesol; tetrahydrolinalool; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the for-mates, acetates, propionates, isobutyrates, butyrates, isovalerates, pentanoates, hexanoates, crotonates, tiglinates and 3-methyl-2-butenoates thereof;

the acyclic terpene aldehydes and ketones such as e.g. geranial; neral; citronellal; 7-hydroxy-3,7-dimethyloctanal; 7-methoxy-3,7-dimethyloctanal; 2,6,10-trimethyl-9-undecenal; geranyl acetone; as well as the dimethyl and diethyl acetals of geranial, neral, 7-hydroxy-3,7-dimethyloctanal; the cyclic terpene alcohols such as e.g. menthol; isopulegol; alpha-terpineol; terpineol-4; menthan-8-ol; menthan-1-ol; menthan-7-ol; borneol; isoborneol; linalool oxide; nopol; cedrol; ambrinol; veti-verol; guajol; and the formates, acetates, propionates, isobutyrates, butyrates, isovalerates, pen-tanoates, hexanoates, crotonates, tiglinates and 3-methyl-2-butenoates thereof;

the cyclic terpene aldehydes and ketones such as e.g. menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalene-8(5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedar wood oil (methyl cedryl ketone);

the cyclic alcohols such as e.g. 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;

the cycloaliphatic alcohols such as e.g. alpha-3,3-trimethylcyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;

the cyclic and cycloaliphatic ethers such as e.g. cineol; cedryl methyl ether; cyclododecyl methyl ether; 1,1-dimethoxycyclododecane; (ethoxymethoxy)cyclododecane; alpha-cedrene epoxide; 3a,6,6,9a tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(l-methylpropyl)-1,3-dioxane;

the cyclic and macrocyclic ketones such as e.g. 4-tert-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; cis-3-methylpent-2-en-1-yl-cyclopent-2-en-1-one; 3-methyl-2-pentyl-2-cyclopenten-1-one; 3-methyl-4-cyclopentadecenone; 3-methyl-5-cyclopentadecenone; 3-methylcyclopentadecanone; 4-(l-ethoxyvinyl)-3,3,5,5-tetramethylcyclohexanone; 4-tert-pentylcyclohexanone; cyclohexadec-5-en-1-one; 6,7-dihydro-1,1,2,3,3-pentamethyl-4(5H)-indanone; 8 cyclohexadecen-1-one; 7-cyclohexadecen-1-one; (7/8)-cyclohexadecen-1-one; 9 cycloheptadecen-1-one; cyclopentadecanone; cyclohexadecanone;

the cycloaliphatic aldehydes such as e.g. 2,4-dimethyl-3-cyclohexenecarbaldehyde; 2-methyl-4-(2,2,6-trimethylcyclohexen-1-yl)-2-butenal; 4-(4-hydroxy-4-methyl pentyl)-3-cyclohexenecarbaldehyde; 4-(4-methyl-3-penten-1-yl)-3-cyclohexenecarbaldehyde; the cycloaliphatic ketones such as e.g. 1-(3,3-dimethylcyclohexyl)-4-penten-1-one; 2,2-dimethyl-1-(2,4-dimethyl-3-cyclohexen-1-yl)-1-propa none; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl 2,6,10-trimethyl-2,5,9-cyclododecatrienyl ketone; tert-butyl(2,4-dimethyl-3-cyclohexen-1-yl) ketone;

the esters of cyclic alcohols such as e.g. 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6 in-denyl propionate; 4,7-methano-3a,4,5,6,7,7a-hexahydro-5 or 6-indenyl isobutyrate; 4,7-methanooctahydro-5 or 6-indenyl acetate;

the esters of cycloaliphatic alcohols such as e.g. 1-cyclohexylethyl crotonate;

the esters of cycloaliphatic carboxylic acids such as e.g. allyl 3-cyclohexylpropionate; allyl cyclo-hexyloxyacetate; cis and trans-methyl dihydrojasmonate; cis and trans-methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolane-2-acetate;

the araliphatic alcohols such as e.g. benzyl alcohol; 1-phenylethyl alcohol, 2-phenylethyl alcohol, 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; l-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

the esters of araliphatic alcohols and aliphatic carboxylic acids such as e.g. benzyl acetate; ben-zyl propionate; benzyl isobutyrate; benzyl isovalerate; 2-phenylethyl acetate; 2-phenylethyl propi-onate; 2-phenylethyl isobutyrate; 2-phenylethyl isovalerate; 1-phenylethyl acetate; alpha-trichloromethylbenzyl acetate; alpha, alpha-dimethylphenylethyl acetate; alpha,alpha-dimethylphenylethyl butyrate; cinnamyl acetate; 2-phenoxyethyl isobutyrate; 4-methoxybenzyl acetate;

the araliphatic ethers such as e.g. 2-phenylethyl methyl ether; 2-phenylethyl isoamyl ether; 2-phenylethyl 1-ethoxyethyl ether; phenylacetaldehyde dimethyl acetal; phenylacetaldehyde diethyl acetal; hydratropaaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxine; 4,4a,5,9b-tetrahydro-2,4-dimethylindeno[1,2-d]-m-dioxine;

the aromatic and araliphatic aldehydes such as e.g. benzaldehyde; phenylacetaldehyde; 3-phenylpropanal; hydratropaaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 2-methyl-3-(4-isobutylphenyl)propanal; 3-(4-tert-butylphenyl)propanal; cin-namaldehyde; alpha-butylcinnamaldehyde; alpha-amylcinnamaldehyde; alpha-hexylcinnamaldehyde; 3-methyl-5-phenylpentanal; 4-methoxy benzaldehyde; 4-hydroxy-3-methoxy-benzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;

the aromatic and araliphatic ketones such as e.g. acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; 2-benzofuranylethanone; (3-methyl-2-benzofuranyl)ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;

the aromatic and araliphatic carboxylic acids and esters thereof such as e.g. benzoic acid; phe-nylacetic acid; methyl benzoate; ethyl benzoate; hexyl benzoate; benzyl benzoate; methyl phe-nylacetate; ethyl phenylacetate; geranyl phenylacetate; phenylethyl phenylacetate; methyl cin-namate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;

the nitrogen-containing aromatic compounds such as e.g. 2,4,6-trinitro-1,3-dimethyl-5-tert-butylbenzene; 3,5-dinitro-2,6-dimethyl-4-tert-butylacetophenone; cinnamonitrile; 3-methyl-5-phenyl-2-pentenonitrile; 3-methyl-5-phenylpentanonitrile; methyl anthranilate; methyl N-methylanthranilate; Schiffs bases of methyl anthranilate with 7-hydroxy-3,7-dimethyloctanal, 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; 2-(3-phenylpropyl)pyridine; indole; skatole; 2-methoxy-3-isopropylpyrazine; 2-isobutyl-3-methoxypyrazine;

the phenols, phenyl ethers and phenyl esters such as e.g. estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;

the heterocyclic compounds such as e.g. 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

the lactones such as e.g. 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis and trans-11-pentadecen-1,15-olide; cis and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3-dihydrocoumarin; octahydrocou-marin.

In a preferred embodiment, the at least one aroma chemical is present in an encapsulated form. In another preferred embodiment, the at least one aroma chemical is present in an unencapsulated form.

In a preferred embodiment, the boiling point of the at least one aroma chemical is in the range of ≥50° C. to ≤350° C. In more preferred embodiment, the boiling point of the at least one aroma chemical is in the range of ≥100° C. to ≤300° C. In yet more preferred embodiment, the boiling point of the at least one aroma chemical is in the range of ≥100° C. to ≤250° C.

Some unencapsulated aroma chemicals and aroma chemical microcapsules have such intense scents that they can be overwhelming to consumers. Thus, for the intense unencapsulated aroma chemicals and/or aroma chemical microcapsules, only a limited mass fraction of one or more of those components is needed to deliver the desired scent experience.

In a preferred embodiment of the presently claimed invention, the shaped body comprises the at least one aroma chemical in an amount in the range of ≥0.1% to ≤20.0% wt. %, alternatively combinations thereof and any whole percentages within any of the aforementioned ranges, based on the total weight of the shaped body. In a preferred embodiment, the shaped body comprises the at least one aroma chemical in an amount in the range of ≥1.0% to ≤15.0% wt. %; in more preferred embodiment, in the range of ≥1.0% to ≤10.0% wt. %, based on the total weight of the shaped body.

The at least one encapsulated aroma chemical can be provided as a plurality of the at least one aroma chemical microcapsule. The at least one aroma chemical microcapsule is preferably an essential oil enclosed within a shell. The shell preferably has an average shell thickness less than the maximum dimension of the at least one aroma chemical core. Preferred is that the at least one aroma chemical microcapsule is a friable aroma chemical microcapsule. Preferred is that the at least one aroma chemical microcapsule, if present, is a moisture activated aroma chemical microcapsule.

Microcapsule

In the context of the presently claimed invention, the microcapsule comprises either a core material and a wall material that at least partially surrounds the core, wherein the core comprises the at least one aroma chemical or the microcapsule comprises a porous matrix, wherein the pores are filled with at least one aroma chemical, which is herein defined as “spherical microparticle”.

In a preferred embodiment, the microcapsule wall material comprises melamine, polyacrylamide, silicones, silica, polystyrene, polyurea, polyurethanes, polyacrylate based materials, polyacrylate esters-based materials, gelatin, styrene malic anhydride, polyamides, aromatic alcohols, polyvinyl alcohol and mixtures thereof. In another preferred embodiment, the melamine wall material comprises melamine crosslinked with formaldehyde, melaminedimethoxyethanol crosslinked with formaldehyde, and mixtures thereof. In another preferred embodiment, the polystyrene wall material comprises polystyrene cross-linked with divinylbenzene. In yet another preferred embodiment, the polyurea wall material comprises urea crosslinked with formaldehyde, urea crosslinked with glutaraldehyde, and mixtures thereof. In yet another preferred embodiment, the polyacrylate based wall materials comprises polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials preferably comprises polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material preferably comprises aryloxyalkanols, arylalkanols and oligoalkanolarylethers. It may also preferably comprise aromatic compounds with at least one free hydroxyl-group, in a more preferred embodiment at least two free hydroxy groups that are directly aromatically coupled, in an even more preferred embodiment at least two free hydroxy-groups are coupled directly to an aromatic ring, and in a most preferred embodiment, positioned relative to each other in meta position. In a preferred embodiment, the aromatic alcohols are selected from phenols, cresols (o-, m-, and p-cresol), naphthols (alpha and beta-naphthol) and thymol, as well as ethylphenols, propylphenols, fluorophenols and methoxyphenols.

The polyurea based wall material preferably comprises a polyisocyanate. In some embodiments, the polyisocyanate is preferably an aromatic polyisocyanate containing a phenyl, a tolyl, a xylyl, a naphthyl or a diphenyl moiety (e.g., a polyisocyanurate of toluene diisocyanate, a trimethylol propane-adduct of toluene diisocyanate or a trimethylol propane-adduct of xylylene diisocyanate), an aliphatic polyisocyanate (e.g., a trimer of hexamethylene diisocyanate, a trimer of isophorone diisocyanate and a biuret of hexamethylene diisocyanate), or a mixture thereof (e.g., a mixture of a biuret of hexamethylene diisocyanate and a trimethylol propane-adduct of xylylene diisocyanate). In still other preferred embodiments, the polyisocyanate is preferably cross-linked, the cross-linking agent being a polyamine (e.g., diethylenetriamine, bis(3-aminopropyl)amine, bis(hexamethylene)triamine, tris(2-aminoethyl)amine, triethylenetetramine, N,N′-bis(3-aminopropyl)-1,3-propanediamine, tetraethylenepentamine, pentaethylenehexamine, branched polyethylenimine, chitosan, nisin, gelatin, 1,3-diaminoguanidine monohydrochloride, 1,1-dimethylbiguanide hydrochloride, or guanidine carbonate).

The polyvinyl alcohol-based wall material preferably comprises a crosslinked, hydrophobically modified polyvinyl alcohol, which comprises a crosslinking agent comprising i) a first dextran aldehyde having a molecular weight of from 2,000 to 50,000 Da; and ii) a second dextran aldehyde having a molecular weight of from greater than 50,000 to 2,000,000 Da.

The microcapsules have a volume based particle size distribution, as determined by static light scattering according to ISO 13320:2009 EN.

In a preferred embodiment, the microcapsules have a particle size (d50) of from ≥0.2 microns to ≤150 microns, in a more preferred embodiment from ≥5 microns to ≤60 micron, in yet more preferred embodiment from ≥1 microns to ≤50 microns, in yet more preferred embodiment from ≥2 microns to ≤40 microns.

In a preferred embodiment, the microcapsules have the core:shell weight ratio in the range of 99:1 to 60:40.

In another preferred embodiment, at least 75%, 85% or even 90% of the microcapsules may have a particle wall thickness of from ≥20 nm to ≤1000 nm, in another preferred embodiment from ≥50 nm to ≤500 nm, in an even more preferred embodiment from ≥600 nm to ≤300 nm.

The following related term, spherical microparticles, denotes a spherically formed polymer microparticle (or polymer microsphere). In one embodiment, this may be microcapsules, i.e. particles, in which a polymer matrix encloses pores that are filled with liquid or gases at room temperature.

Fillable spherical microparticles have openings on the surface thereof, such that an exchange of the material inside is possible. In the case of microcapsules, these are holes in the outer polymer layer, often also referred to as microcapsule shell or microcapsule wall. There are however also embodiments with porous spherical microparticles, which have a polymer matrix form. In these cases, this is a connected porous network that has openings at the surface of the microparticle.

Furthermore, there are embodiments of microparticles, the morphology of which has both.

The microparticles are formed by removal of the solvent in a w/o/w emulsion. In the first step, an emulsion of water droplets or droplets of the aqueous pore former solution is formed in the polyester solution. This w/o emulsion is in turn emulsified in water and the water-immiscible solvent is removed. By removing the solvent of the polyester, the latter becomes insoluble and becomes deposited at the surface of the water droplets or the aqueous pore former droplets. During this wall forming process, the pores are simultaneously formed, advantageously by the pore former.

Pore formers are for example compounds which release gas under the operating conditions of step b).

Pore formers are for example gas-releasing agents preferably selected from ammonium carbonate, sodium carbonate, ammonium hydrogencarbonate, ammonium sulfate, ammonium oxalate, sodium hydrogencarbonate, ammonium carbamate and sodium carbamate.

Furthermore, water-soluble low molecular weight compounds that create an osmotic pressure are suitable as pore formers. Upon removal of the water-insoluble solvent, a concentration gradient forms on account of the concentration gradient between the inner aqueous droplets with pore former and the outer aqueous disperse phase, which concentration gradient leads to migration of the water in the direction of the inner droplets and hence to for-mation of pores. Such pore formers are preferably selected from sugars such as monosaccharides, disaccharides, oligosaccharides and polysaccharides, urea, inorganic alkali metal salts such as sodium chloride and inorganic alkaline earth metal salts such as magnesium sulfate and calcium chloride. Particular preference is given to glucose and sucrose and urea.

Furthermore, polymers that are soluble in both phases, such as polyethylene glycol (PEG) and polyvinylpyrrolidone (PVP) are suitable as pore formers. Since these polymers are soluble in both phases, they migrate, because of diffusion, from the aqueous phase into the oil phase.

The methods for preparing the spherical microparticles always lead to a population of microparticles, as a result of which the term “composition of spherical microparticles” is also used.

The microparticles have a mean particle diameter of D[4,3] from 10 to 600 (volume-weighted average, determined by means of light scattering). According to a preferred embodiment, the mean particle diameter D[4,3] is 1 to <100, preferably to 30 μm. According to a likewise preferred embodiment, the mean particle diameter D[4,3] is 100-500 μm.

The microparticles have at least 10 pores at their surface, preferably at least 20 pores, the diameter of which is in the range from 1/5000 to ⅕ of the mean particle diameter, and furthermore the diameter of each of these pores is at least 20 nm. The microparticles preferably have on average at least 10 pores, preferably at least 20 pores, the diameter of which is in the range from 1/500 to ⅕ of the mean particle size, and furthermore the diameter of each of these pores is at least 20 nm. In a preferred embodiment, the microparticles, of mean particle diameter 100-500 μm, preferably have pores having a mean diameter in the range from 1/500 to 1/100 of the mean particle diameter. In each case, those microparticles of the composition of spherical microparticles whose particle diameter does not deviate from the mean particle diameter by more than 20% are taken into consideration. Of these, at least 80% meet the required number of pores at the particle surface.

In a preferred embodiment, an aliphatic-aromatic polyester is used. This term is understood to mean the esters based on aromatic dicarboxylic acids and aliphatic dihydroxy compounds. The aromatic dicarboxylic acids may also be used in a mixture with aliphatic dicarboxylic acids here. Aliphatic-aromatic polyesters are preferably polyesters based on aliphatic and aromatic dicarboxylic acids with aliphatic dihydroxy compound, what are referred to as semiaromatic polyesters. These polymers may be present individually or in the mixtures thereof.

The aliphatic-aromatic polyesters used according to have a glass transition temperature (determined using differential scanning calorimetry (DSC), DIN EN ISO 11357) or a melting point in the range from 45 to 140° C.

In a preferred embodiment, “aliphatic-aromatic polyesters” is also understood to mean polyester derivatives such as polyether esters, polyester amides or polyether ester amides and polyester urethanes (see EP application no. 10171237.0). The suitable aliphatic-aromatic polyesters include linear, non-chain-extended polyesters (WO 92/09654). Preference is given to chain-extended and/or branched aliphatic-aliphatic polyesters. The latter are known from WO 96/15173 to 15176, 21689 to 21692, 25446, 25448 or WO 98/12242, which are hereby explicitly incorporated by reference. Likewise considered are mixtures of different aliphatic-aromatic polyesters. Interesting recent developments are based on renewable raw materials (see WO-A 2006/097353, WO-A 2006/097354 and also WO 2010/034710).

In a preferred embodiment, the spherical microparticles are prepared, wherein
a) an emulsion is prepared from water or preferably an aqueous solution of a pore former as discontinuous phase and a continuous phase comprising a solution of at least one aliphatic-aromatic polyester in a water-immiscible solvent,
b) the w/o emulsion obtained in a) is emulsified in water in the presence of a dispersant to give a w/o/w emulsion having droplets with a mean size of 10-600 μm, and the water-immiscible solvent is removed at a temperature in the range from 20 to 80° C.,
c) the spherical microparticles formed in method step b) are separated off and optionally dried.

In yet another preferred embodiment, the continuous phase prepared under a) comprises the aliphatic-aromatic polyester and also at least one further dissolved polymer selected from polyacrylate, polyamide, polycarbonate, polystyrene, aliphatic-aliphatic polyester, aromatic-aromatic polyester, polyolefin, polyurea and polyurethane. Especially preferred are polylactic acid, polycaprolactone, polybutylene succinate, polybutylene succinate adipate, polyhydroxyalkanoates.

In a preferred embodiment, the microparticles are loaded such that they should release the atleast one aroma chemical only after a latency period. In particular, it is desirable to deliberately control the release of the atleast one aroma chemical. For example, it may be desirable for the delivery rates to be as constant as possible over an extended period of time. In other cases, it is desirable to achieve a rapid release of the atleast one shaped body after the latency. The loaded microparticles should be preparable in a simple process and be inert to the atleast one aroma chemical.

In a preferred embodiment, a process for the preparation of microparticles which are loaded with at least one aroma chemical wherein the microparticles are composed of an organic, polymeric wall material and in the unloaded state have at least one cavity in the interior, which has pores with the surface the microparticle is attached, taking one of the following measures (a), (b), (c) or (d):

Measure (a):

The unloaded microparticles are filled with a liquid (1a) consisting essentially of:
i) the at least one aroma chemical which is present in the liquid as a melt, emulsified, suspended or dissolved,
ii) at least one non-polymerisable substance A which is solid at room temperature and which is present in the liquid as a melt, emulsified, suspended or dissolved, and
iii) optionally one or more solvents,

The microparticles are impregnated with liquid (1a), and optionally, any solvent present is removed;

Measure (b):

The unloaded microparticles are filled with a liquid (1b) consisting essentially of:
i) the at least one aroma chemical which is present in the liquid as a melt, emulsified, suspended or dissolved,
ii) at least one polymerizable substance B which is emulsified or dissolved in the liquid,
iii) optionally a non-polymerisable substance A which is solid at room temperature and which is present in the liquid as a melt, emulsified, suspended or dissolved, and
iv) optionally one or more solvents,

The microparticles are impregnated with liquid (1b), wherein subsequently a polymerization of the substance B is effected and, if appropriate, optionally, any solvent present is removed,

Measure (c):

The unloaded microparticles are filled with a liquid (1c) consisting essentially of:
i) the at least one aroma chemical which is present in the liquid as a melt, emulsified, suspended or dissolved,
ii) at least one substance C which is dissolved or melted in the liquid and can be solidified by adding polyvalent ions,
iii) optionally a non-polymerisable substance A which is solid at room temperature and which is present in the liquid as a melt, emulsified, suspended or dissolved, and
iv) optionally one or more solvents,

The microparticles are impregnated with liquid (1c), then adding a solution of polyvalent ions to effect solidification, e.g. a precipitate, the substance C to cause and, if necessary, but not necessarily any solvent present removed.

Measure (d):

On the surface of the microparticles, which are already loaded with at least one aroma chemical, a substance is applied, which closes the pores of the loaded microparticles. The loading of the unloaded microparticles with the at least one aroma chemical is carried out by impregnating the microparticles with a liquid (Id) containing the aroma chemical.

In a preferred embodiment, by the measures (a), (b), (c) and (d) the at least one aroma chemical is enclosed in the microparticles after filling. Here, the substances used in the measures (a), (b) and (c) (A), (B) and (C)—in the case of the substances (B) and (C) after their solidification by polymerization or by treatment with the polyvalent metal ions, a solid matrix that includes the at least one aroma chemical. In the case of measure (d), inclusion is achieved by sealing the pores with a substance applied to the surface of the pores, in particular by forming a solid layer on the surface of the loaded microparticles which results in closure of the pores.

In yet another preferred embodiment, the non-polymerizable substance A is selected from waxes or organic polymers which melt at a temperature in the range of 30 to 150° C., organic polymers which are solubilizable in the solvent optionally contained, and waxes and mixtures thereof.

In yet another preferred embodiment, the polymerizable substance B selected ethylenically unsaturated monomers, hydroxyl or alkoxyl-containing silanes and oxidatively polymerizable aromatic compounds.

In yet another preferred embodiment, substance C is typically a polymer containing a variety of anionic or acidic groups, e.g. carboxylic groups or sulfonic acid groups, which form on contact with polyvalent ions, such as Ca 2+, insoluble salts or complexes. Typical examples of such polymers are polysaccharides bearing carboxyl groups or sulfonic acid groups, e.g. alginates, pectins and carrageen which are formed and solidified by contact with polyvalent ions, for example Ca 2+ chelates. Further examples of such substances C are water-soluble inorganic salts which form with multivalent ions, such as Ca 2+, insoluble salts, e.g. alkali metal carbonates and ammonium carbonate.

In yet another preferred embodiment, the filled microparticles are closed by coalescence of the pores, by the suspension, depending on the polymer of the microparticle that forms the wall material, being heated to above its melting point or to above its glass transition temperature when it does not have a melting point.

In a preferred embodiment, the at least one aroma chemical microcapsule is preferably coated with a deposition aid, a cationic polymer, a non-ionic polymer, an anionic polymer, or mixtures thereof. Suitable polymers are preferably selected from the group consisting of polyvinyl formaldehyde, partially hydroxylated polyvinyl formaldehyde, polyvinylamine, polyethyleneimine, ethoxylated polyethyleneimine, polyvinylalcohol, polyacrylates, and combinations thereof.

In a preferred embodiment, the microcapsule is preferably the at least one aroma chemical microcapsule. In a preferred embodiment, one or more types of microcapsules, for examples two microcapsules types, wherein one of the first or second microcapsules (a) has a wall made of a different wall material than the other; (b) has a wall that includes a different amount of wall material or monomer than the other; or (c) contains a different amount of the at least one aroma chemical than the other; or (d) contains a different aroma chemical are preferably used.

Shaped body and a composition comprising the at least one shaped body

In a preferred embodiment, the presently claimed invention provides the shaped body wherein the shaped body has a disk-like, spherical or cuboidal shape. In a preferred embodiment, the shaped body has the rounded corners.

In a preferred embodiment, the presently claimed invention relates to the shaped body, wherein the shaped body has a weight in the range of ≥0.1 mg to ≤5.0 g. In a more preferred embodiment, the shaped body has a weight in the range of ≥2 mg to ≤150 mg, in yet more preferred embodiment, in the range of ≥5 mg to ≤150 mg, in even more preferred embodiment, in the range of ≥5 mg to ≤100 mg, in particular in the range of ≥5 mg to ≤50 mg.

In a preferred embodiment, the at least one shaped body comprises the at least one encapsulated aroma chemical or the at least one unencapsulated aroma chemical in an amount in the range of ≥0.1% to ≤20.0% wt. %, based on the total weight of the shaped body.

In a preferred embodiment, the at least one shaped body comprises at least one unencapsulated aroma chemical and the at least one aroma chemical microcapsule but is free or essentially free of other aroma chemical carriers. In another preferred embodiment, the at least one shaped body comprises at least one unencapsulated aroma chemical and the at least one aroma chemical microcapsule and is free of other aroma chemical carriers.

An embodiment of the presently claimed invention is a composition comprising the at least one shaped body comprising
a) at least one graft copolymer (I) comprising
   i) a polyether and
   ii) one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl, and
b) at least one aroma chemical.

In a preferred embodiment, the at least one shaped body in the composition is present in an amount in the range of ≥0.1% to ≤100% wt. %, based on the total weight of the composition. In yet another preferred embodiment, the composition is present in the form of solid, liquid, pastes, dispersions or gel.

In a preferred embodiment, the presently claimed composition comprising at least one shaped body is used as an agent selected from the group consisting of perfumes, washing and cleaning agents, cosmetic agents, body care agents, hygiene articles, food, food supplements and scent dispensers. In a preferred embodiment, the presently claimed composition comprising at least one shaped body is used as an agent selected from the group consisting of perfumes, washing and cleaning agents, in a more preferred embodiment as fabric washing agent.

In yet another preferred embodiment, the at least one shaped body and the composition comprising the at least one shaped body are therefore well suited for use in one of the following products:
an acidic, alkaline or neutral cleaner which is selected in particular from the group consisting of all-purpose cleaners, floor cleaners, window cleaners, dishwashing detergents, bath and sanitary cleaners, scouring milk, solid and liquid toilet cleaners, powder and foam carpet cleaners, liquid detergents, powder detergents, laundry pretreatments such as bleaches, soaking agents and stain removers, fabric softeners, washing soaps, washing tablets, disinfectants, surface disinfectants,
an air freshener in liquid form, gel-like form or a form applied to a solid carrier or as an aerosol spray,
a wax or a polish, which is selected in particular from the group consisting of furniture polishes, floor waxes and shoe creams, or
a body care composition, which is selected in particular from the group consisting of shower gels and shampoos, shaving soaps, shaving foams, bath oils, cosmetic emulsions of the oil-in-water type, of the water-in-oil type and of the water-in-oil-in-water type, such as e.g. skin creams and lotions, face creams and lotions, sunscreen creams and lotions, after-sun creams and lotions, hand creams and lotions, foot creams and lotions, hair removal creams and lotions, aftershave creams and lotions, tanning creams and lotions, hair care products such as e.g. hairsprays, hair gels, setting hair lotions, hair conditioners, permanent and semipermanent hair colorants, hair shaping compositions such as cold waves and hair smoothing compositions, hair tonics, hair creams and hair lotions, deodorants and antiperspirants such as e.g. underarm sprays, roll-ons, deodorant sticks, deodorant creams, products of decorative cosmetics.

In another embodiment, the composition comprising the at least one shaped body shows increased aroma retention and aroma longevity.

In a preferred embodiment of the presently claimed invention, the composition may have a total solids content in the range of from ≥90.0 to ≤99.9 wt. %; in a more preferred embodiment in the range of from ≥95.0 to ≤99.0% wt. %, based on the total weight of the composition.

Such presently claimed inventive composition is, e. g., present in the form of a powder or a tablet.

In a preferred embodiment of the presently claimed invention, the composition may have a total solids content in the range of from ≥15 to ≤40% wt. %. Such presently claimed inventive composition is, e. g., present in the form of a paste or a gel.

The making of the respective composition also needs to meet numerous requirements. Liquid and solid compositions should have a good storage stability. Shaped bodies—such as, but not limited to—tablets should not break upon manufacture. This is a particular challenge in the case of fabric detergent compositions that contain mixed hydroxymethyl ethers, so-called “HME” or HME-ethers.

A more significant scent experience can be provided after washing the laundry when the at least one aroma chemical microcapsule is deposited on the fabric and after the at least one aroma chemical from the microcapsule is released. An unencapsulated aroma chemical is desirable to provide scent to the at least one shaped body so that the user of the at least one shaped body experiences a pleasant smell when the user dispenses the at least one shaped body or opens a container containing the shaped bodies.

In yet another embodiment, the composition comprising at least one shaped body further comprises at least one ingredient selected from the group consisting of builders, cobuilders, optical brighteners, bleaches, bleach boosters, bleach catalysts, bleach activators, surfactants, soil release agents, dye transfer agents, dispersants, enzymes, suds suppressers, dyes, colorants, fillers, hydrotropes, photoactivators, fluorescers, fabric conditioners, hydrolyzable surfactants, preservatives, anti-oxidants, deposition aids, chelants, stabilizers, anti-shrinkage agents, anti-wrinkle agents, germicides, fungicides, anti-corrosion agents and mixtures thereof.

Builders and cobuilders—The builders can be included in the composition herein to assist in controlling mineral hardness. Inorganic as well as organic builders can be used. Builders are typically used in fabric laundering compositions to assist in the removal of paniculate soils. The level of builder can vary widely depending upon the end use of the composition and its desired physical form. When present, the composition will typically comprise at least 1 wt. % builder. Composition may comprise from ≥5 wt. % to ≤50 wt. % of builder and/or cobuilder, based on the total weight of composition.

Inorganic or phosphorus-containing builders include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates.

The examples of cobuilders are phosphonates, for example hydroxyalkanephosphonates and aminoalkanephosphonates. Among the hydroxyalkanephosphonates, 1-hydroxyethane-1,1-diphosphonate (HEDP) is of particular importance as a cobuilder. It is preferably used as the sodium salt, the disodium salt giving a neutral reaction and the tetrasodium salt an alkaline reaction (pH 9). Suitable aminoalkanephosphonates are preferably ethylenediaminetetramethylenephosphonate (EDTMP), diethylenetriaminepentamethylenephosphonate (DTPMP) and higher homologs thereof. They are preferably used in the form of the neutrally reacting sodium salts, e.g. as hexasodium salt of EDTMP or as hepta- and octasodium salt of DTPMP. Moreover, amphoteric polymers can also be used as cobuilders.

Optical brighteners—include materials referred to as fluorescent whitening agents or fluorescent brightening agents. Such materials act to optically compensate for the yellow cast of substrates resulting from use and age. The optical brightener emits short wavelength light in the violet to blue wavelengths comprising 400 to 490 nm and absorb in the typically ultraviolet wavelengths of about 250 to 400 nm. Preferred optical brighteners are colorless on the fabric.

The choice of optical brighteners for use in the presently claimed composition will depend upon a number of factors, such as the nature of other components present in the composition, the temperature of the wash water, the degree of agitation, and the ratio of the material washed to the tub size. The brightener selection is also dependent upon the type of material to be cleaned, e.g., cottons, synthetics, etc.

Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.).

Bleaches, Bleach Boosters, Bleach Catalysts and Bleach Activators

In the context of the presently claimed invention, bleach can be selected from oxygen bleaches and chlorine-containing bleaches.

Examples of suitable oxygen bleaches are sodium perborate, anhydrous or for example as monohydrate or as tetrahydrate or so-called dihydrate, sodium percarbonate, anhydrous or, for example, as monohydrate, hydrogen peroxide, persulfates, organic peracids such as peroxylauric acid, peroxystearic acid, peroxy-α-naphthoic acid, 1,12-diperoxydodecanedioic acid, perbenzoic acid, peroxylauric acid, 1,9-diperoxyazelaic acid, diperoxyisophthalic acid, in each case as free acid or as alkali metal salt, in particular as sodium salt, also sul-fonylperoxy acids and cationic peroxy acids.

The presently claimed composition comprises, for example, in the range from 0.5 to 15 wt. % by weight of oxygen bleach, based on the total weight of the composition.

Suitable chlorine-containing bleaches are, for example, 1,3-dichloro-5,5-dimethylhydantoin, N—N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate. The presently claimed composition comprises in the range from 3 to 10 wt. % of chlorine bleach, based on the total weight of the composition.

The presently claimed composition comprises one or more bleach catalysts. The bleach catalysts can be selected from bleach-boosting transition metal salts or transition metal complexes such as, for example, manganese-, iron-, cobalt-, ruthenium- or molyb-denumsalen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Further, the presently claimed composition comprises one or more bleach boosters. The bleach boosters provide superior bleaching effectiveness in lower water temperatures as well as superior color safety profiles. The bleach booster can be selected from the group consisting of zwitterionic imines, anionic imine polyions having a net negative charge of from about −1 to about −3, and mixtures thereof. The presently claimed composition comprises in the range from about 0.001 wt. % to about 10 wt. % of bleach booster, based on the total weight of the composition.

In a preferred embodiment, the presently claimed composition comprises one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts). Other examples of suitable bleach activators are tetraacetylethylenediamine (TAED) and tetraacetylhexylenediamine.

Surfactants—For the purpose of the presently claimed invention, the surfactants are selected from the group consisting of nonionic surfactants, anionic surfactants and zwitterionic surfactants as well as mixtures thereof.

Preferred nonionic surfactants have the general formula (II)

R²—CH(OH)—CH₂—O-(AO)_{X}—R³ formula (II)

R² is selected from C₄-C₃₀-alkyl, straight-chain or branched, and from C₄-C₃₀-alkylene, straight-chain or branched, with at least one C—C double bond, preferred is C₄-C₃₀-alkyl, straight-chain or branched, more preferred is straight-chain C₄-C₃₀-alkyl and even more preferred is n-C₁₀-C₁₂-alkyl;

R³ is selected from C₁-C₃₀-alkyl, straight-chain or branched, and from C₂-C₃₀-alkylene, straight-chain or branched, with at least one C—C double bond, preferred is C₆-C₂₀-alkyl, more preferred is C₈-C₁₂-alkyl, even more preferred C₁₀-C₁₂-alkyl;

x is selected from 1 to 100, preferred is from 5 to 60, more preferred is from 10 to 50, and even

more preferred is from 20 to 40;

AO is selected from identical or different alkylene oxides, selected from CH₂—CH₂—O, (CH₂)₃—O, (CH₂)₄—O, CH₂CH(CH₃)—O, CH(CH₃)—CH₂—O— and CH₂CH(n-C₃H₇)—O. Preferred example of AO is CH₂—CH₂—O (EO).

For the purpose of presently claimed invention, (AO)x can be selected from (CFH₂CH₂O)ₓ1, x1 being selected from 1 to 50. For the purpose of the presently claimed invention, (AO)x is selected from —(CH₂CH₂O)ₓ₂—(CH₂CH(CH₃)—O)ₓ₃ and —(CH₂CH₂O)ₓ₂—(CH(CH₃)CH₂—O)ₓ₃, x2 and x3 being identical or different and selected from 1 to 30. Further, (AO)x is selected from —(CFH₂CFH₂O)ₓ₄, x4=being in the range of from 10 to 50, AO being EO, and R² and R³ each being independently selected from C₈-C₁₄-alkyl.

In the context of the presently claimed invention, x or x1 or x2 and x3 or x4 are to be understood as average values, the number average being preferred. Therefore, each x or x1 or x2 or x3 or x4—if applicable—refers to a fraction although a specific molecule can only carry a whole number of alkylene oxide units.

For the purpose presently claimed invention, the nonionic surfactant is selected from group consisting of alkoxylated alcohols and alkoxylated fatty alcohols, di- and multiblock copolymers of ethylene oxide and propylene oxide and reaction products of sorbitan with ethylene oxide or propylene oxide, alkyl glycosides and so-called amine oxides.

Preferred examples of alkoxylated alcohols and alkoxylated fatty alcohols are, for example, compounds of the general formula (III)

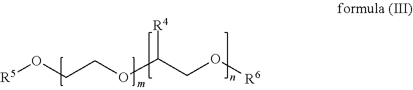

in which the variables are defined as follows:

R⁴ is identical or different and selected from linear C₁-C₁₂-alkyl, preferably in each case identical

and ethyl and particularly preferably methyl,

R⁵ is selected from C₈-C₂₂-alkyl, for example n-C₈H₁₇, n-C₁₀H₂₁, n-C₁₂H₂₅, n-C₁₄H₂₉, n-C₁₆H₃₃ or n-C₁₈H₃₇,

R⁶ is selected from hydrogen and from C₁-C₁₂-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethyl hexyl, n-nonyl, n-decyl, isodecyl, n-dodecyl or iso-dodecyl,

“m” and “n” are in the range from zero to 300, where the sum of n and m is at least one. Preferred is that “m” is in the range from 1 to 100 and n is in the range from 0 to 30.

Other preferred examples of alkoxylated alcohols and alkoxylated fatty alcohols are, for example, compounds of the general formula (IV)

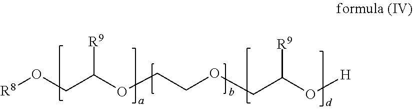

in which the variables are defined as follows:

R⁹ is identical or different and selected from linear C₁-C₄-alkyl, preferably identical in each case and ethyl and particularly preferably methyl;

R⁸ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,

“a” is a number in the range from 1 to 6; “b” is a number in the range from 4 to 20 and “d” is a number in the range from 4 to 25.

Compounds of the general formula (IV) are preferably block copolymers or random copolymers, more preferably block copolymers.

Further suitable nonionic surfactants are selected from di- and multiblock copolymers, composed of ethylene oxide and propylene oxide. Further suitable nonionic surfactants are selected

from ethoxylated or propoxylated sorbitan esters. Amine oxides or alkyl polyglycosides are likewise suitable. An overview of suitable further nonionic surfactants can be found in EP-A 0 851 023 and in DE-A 198 19 187.

Mixtures of two or more different nonionic surfactants may also be present.

Examples of anionic surfactants are C₈-C₂₀-alkyl sulfates, C₈-C₂₀-alkylsulfonates and C₈-C₂₀-alkyl ether sulfates with one to 6 ethylene oxide units per molecule.

The presently claimed composition comprises in the range from 3.0 to 20.0 wt. % of surfactants, based on the total weight of composition.

Enzymes—in the context of the presently claimed invention, the composition may comprise the enzymes for a variety of purposes, including removal of protein-based, carbohydrate-based, or triglyceride-based stains from surfaces such as textiles, for the prevention of refugee dye transfer, for example in laundering, and for fabric restoration. Suitable enzymes include proteases, amylases, lipases, cellulases, peroxidases, and mixtures thereof of any suitable origin, such as vegetable, animal, bacterial, fungal and yeast origin. Preferred se-lections are influenced by factors such as pFH-activity and/or stability optima, thermostability, and stability to active detergents, builders and the like. In this respect bacterial or fungal enzymes are preferred, such as bacterial amylases and proteases, and fungal cellulases.

Enzymes are normally incorporated into composition at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics. Stated otherwise, the composition may comprise from 0.001 wt. % to 5 wt. %, of an enzyme, based on total weight of the composition.

Deposition aids—for the purpose of the presently claimed invention, the “deposition aids” is a generic term for compounds which help in deposition of at least one shaped body on to the fabric during wash cycle.

Dispersants—for the purpose of the presently claimed invention, the “dispersants” is a term for compounds which prevent or minimize the flocculation of the insoluble solid detergent particles. The dispersed solid detergent particles remain in a finely divided state so that it does not adhere to surfaces of fabric and can be washed away during wash cycle rinsing.

Soil release agents—for the purpose of the presently claimed invention, the “soil release agents” are substances that modify the surface of the fabric to make it more resistant to oily soils. These substances prevent the subsequent soiling of the fabric.

Suds supressors—for the purpose of presently claimed invention, the suds supressors are the compounds which are added to the detergent composition to prevent excess foam production. The suds supressors are foam suppressors or controlling agents used to prevent suds-overflow from the washing machine or under-usage of product by the user.

Preferred amount of suds supressors to the presently claimed composition can be such that it results in the foaming which will be sufficiently low to avoid oversudsing under all conceivable washing machine temperatures, load and soil conditions, but sufficiently high to meet the consumers preference for a moderate to generous level of foam.

Dyes—are compounds that can be added to the presently claimed composition for the aesthetic appeal to the customer.

Colorants—for the purpose of the presently claimed composition, colorants are the compounds which are stable to the alkalis, have very good light fastness and do not stain the fabric in wash baths.

Fillers—for the purpose of the presently claimed invention, fillers can be solid or liquid.

For liquid composition, the water and other solvents can be fillers. Low molecular weight primary or secondary alcohols exemplified by methanol, ethanol, propanol, and isopropanol are suitable. Monohydric alcohols are preferred for solubilizing surfactant, but polyols such as those containing from 2 to about 6 carbon atoms and from 2 to about 6 hydroxy groups (e.g., 1,3-propanediol, ethylene glycol, glycerine, and 1,2-propanediol) can also be used. Amine containing solvents, such as ammonia, amines, or alkanolamines, and alkanolamines may also be used.

The presently claimed composition may contain from 0.05 wt. % to 90 wt. % of fillers, based on the total weight of the composition.

For solid composition including powder, suitable fillers include but are not limited to sodium sulfate, sodium chloride, clay, or other inert solid ingredients. Fillers may also include bio-mass or decolorized biomass. Typically, fillers in granular, bar, or other solid compositions comprise ≥80 wt. % of filler, based on total weight of the composition.

Hydrotropes—for the purpose of the presently claimed invention, hydrotropes are the compounds that provide optimum viscosity and stability to the composition.

Photoactivators—are the compounds that are capable of absorbing electromagnetic radiation in the visible light range and releasing the absorbed energy quanta in a form that provides bleaching action on fabrics.

Fluorescers—are the compounds which can be conventionally used in the composition to give improved whiteners. For the purpose of the presently claimed composition, the fluorescers do not have an undesirable colour. Also, incorporating such fluorescers in composition do not impair the colour quality of the final composition.

Fabric conditioners—contain surfactants which have lubricant properties and are electrically conductive. The surfactants prevent static electricity and make the fabrics feel smoother.

In addition, the fabric conditioners can often provide a thin coating on the fabric fibres to make the fabric fluffier, softer and better smelling.

Preferred are the two main types of fabric softener; those that use cationic surfactants and those that use anionic surfactants. For the purpose of the presently claimed invention, the choice of softener can vary depending on the fabric to be treated. Some softeners are more suitable for cellulose-based fibres, whilst others have a higher affinity to hydrophobic materials such as nylon, polyethylene terephthalate, polyacrylonitrile, etc. Softeners are usually prepared as an emulsion, as the surfactants are frequently hydrophobic.

Preservatives—are the compounds that can be added to the presently claimed composition at the time of manufacturing in order to protect the product against microbial contamination in the long term. A wide variety of such preservatives are known and used. The precise choice of type and level of the preservative is usually made by the formulator based upon a number of factors including, for example, the microbiological requirements of the product, cost, the pH of the product, compatibility with the other formulation ingredients and regulatory restrictions.

Anti-oxidants—are the compounds that can be added to the presently claimed composition to reduce or prevent the effects of oxidation processes. These effects can manifest them-selves during storage or during use of the composition.

Examples of the unwanted effects of oxidation processes are: malodour, discoloration, perfume degradation, deactivation of ingredients such as organic surfactants, bleach, enzymes and change in properties of ingredients of the composition. Preferred anti-oxidants do not give unwanted discoloration with some aroma chemicals on storage.

Chelants—are the widely used chemicals that can control adverse effects of the metal ions in detergent compositions by chelating the metal. The chelants are often organic compounds, which form multiple bonds with a single metal ion. Chelants can be introduced into the composition in an acid form or in a salt form. Normally the salt form increases the water-solubility of the chelant.

Additionally, the chelants need to be stable in composition during the storage.

Stabilizers—for the purpose of presently claimed composition, stabilizers are the compounds that can be added to prevent discoloration and rancidity of the composition during storage or use.

Anti-shrinkage agents—are the compounds that prevent the shrinkage of the fabric during and after the wash cycle.

Anti-wrinkle agents—are the substances which deliver the benefit of wrinkle reduction to the laundered item during the cleaning step and, therefore, reduce the need for further wrinkle reducing steps when the fabrics are taken from the dryer or after hang drying.

Preferred substances that facilitate the benefit of wrinkle reduction are believed to lubricate fiber surfaces. By lubricating the fiber surfaces of garments, for example, the fibers slide more easily relative to each other and are less likely to entangle, resulting in less wrinkles.

Germicides—are the substances that are designed to kill and destroy germs and bacteria.

These can be in the form of liquid or solid and can be added to the presently claimed composition.

Fungicides—are the biocidal compounds or biological organisms used to kill parasitic fungi or their spores.

Anti-corrosion agents—are the substances that reduce the magnitude and rate of the process of corrosion, or even to prevent it from taking place altogether. Preferred anti corrosive agents for the presently claimed composition inhibit corrosion during the washing stage of the cleaning cycle, the all rinsing stages and the final air-drying stage of the cleaning cycle.

Process to Prepare the Shaped Body

An embodiment of the presently claimed invention provides a process for preparing the shaped body comprising at least the steps of

A) melting at least one graft copolymer (I) comprising

i) a polyether and

ii) one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl,

B) mixing the at least one melted graft copolymer (I) with at least one aroma chemical to obtain a molten mixture of the at least one graft copolymer (I) and the at least one aroma chemical; and

C) forming the molten mixture of the at least one graft copolymer (I) and the at least one aroma chemical into a shaped body.

In a preferred embodiment, the step B) comprises mixing the at least one melted graft copolymer (I) with the at least one aroma chemical microcapsule to obtain a molten mixture of the at least one graft copolymer (I) and the at least one aroma chemical microcapsule. In another preferred embodiment, the step B) comprises mixing the at least one melted graft copolymer (I) with an unencapulated the at least one aroma chemical to obtain a molten mixture of the at least one graft copolymer (I) and the unencapsulated at least one aroma chemical. In yet another preferred embodiment, the step B) comprises mixing the at least one melted graft copolymer (I) with an unencapsulated the at least one aroma chemical and the at least one aroma chemical microcapsule to obtain a molten mixture of the at least one graft copolymer (I) and unencapsulated the at least one aroma chemical and the at least one aroma chemical microcapsule.

In another embodiment, the step (C) of the process for preparing a shaped body comprises at least one of the following methods:

dropping and/or spraying the molten mixture of the at least one graft copolymer (I) and the at least one aroma chemical onto a surface or

passing the molten mixture of the at least one graft copolymer (I) and the at least one aroma chemical through small openings or

depositing the molten mixture of the at least one graft copolymer (I) and the at least one aroma chemical into a mold.

In yet another embodiment, the step (A) of the process for preparing a shaped body comprises heating the at least one graft copolymer (I) to a temperature in the range of ≥30° C. to ≤120° C. Preferably, the melting temperature of the at least one graft copolymer (I) is below the boiling point of the at least one aroma chemical.

In an embodiment, the presently claimed invention relates to a use of the shaped body for the controlled release of the at least one aroma chemical.

In another embodiment, the presently claimed invention relates to a method for controlling the release of the at least one aroma chemical, wherein the at least one aroma chemical is comprised by the shaped body.

General Procedure for the Preparation of the Graft Copolymer (I)

A reaction vessel with stirrer and three feeds was charged with polyether and heated to a suitable temperature and purged with nitrogen. Solution of radical starter, such as tert.-butyl-peroctoate was used as a 25% by weight solution in tripropylene glycol, was fed through feed 1 over a period of time. After the commencement of feed 1, a suitable amount of formula (IA), (IB) or (IC) was fed continuously through feed 2 over a period of time. After addition of feed 1 was completed, feed 3 (solution of radical starter) was commenced. After the addition of the radical starter had been completed the reaction mixture was stirred at 100° C. for another hour. Then, the pressure was set to 10 mbar, and volatile components were removed at 100° C. and 10 mbar under stirring. The reaction mixture was then cooled to ambient temperature to obtain the graft copolymer (I).

In the following, there is provided a list of embodiments to further illustrate the present disclosure without intending to limit the disclosure to the specific embodiments listed below.

1. A shaped body comprising
a) at least one graft copolymer (I) comprising
   i) a polyether and
   ii) one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl, and
b) at least one aroma chemical.

2. The shaped body according to embodiment 1, wherein the polyether is selected from the group consisting of polyethylene glycol, polypropylene glycol and ethylene oxide-propylene oxide block copolymer.

3. The composition according to embodiment 1, wherein the polyether is capped with C₃-C₂₀-alkyl or C₆-C₂₀-2-hydroxyalkyl.

4. The composition according to embodiment 3, wherein the polyether is capped with C₃-C₄-alkyl or C₆-C₂₀-2-hydroxyalkyl.

5. The shaped body according to any of embodiments 1 to 4, wherein the graft copolymer (I) has a number average molecular weight Mₙ in the range of ≥2250 to ≤25000 g/mol.

6. The shaped body according to any of embodiments 1 to 5, wherein the graft copolymer (I) has a weight ratio of polyether to side chains in the range of from 95:5 to 3:2.

7. The shaped body according to any of embodiments 1 to 6, wherein the graft copolymer (I) is present in an amount in the range of ≥80.0% to ≤99.9% wt. %, based on the total weight of the shaped body.

8. The shaped body according to any of embodiments 1 to 7, wherein R₁ is selected from the group consisting of n-hexyl, isohexyl, sec-hexyl, n-heptyl, n-octyl, 2-ethyl hexyl, n-nonyl, n-decyl or isodecyl, n-dodecyl, n-C₁₂H₂₅, n-C₁₄H₂₉, n-C₁₆H₃₃, n-C₁₈H₃₇, n-hexenyl, isohexenyl, n-heptenyl, n-octenyl, n-decenyl and n-dodecenyl.

9. The shaped body according to any of embodiments 1 to 8, wherein the compound of formula (IA) is selected from the group consisting of 2-ethylhexyl(meth)acrylate, 2-n-propylheptyl(meth)acrylate, stearyl(meth)acrylate, lauryl(meth)acrylate, lauryl acrylate, palmityl(meth)acrylate and myristyl(meth)acrylate.

10. The shaped body according to any of embodiments 1 to 9, wherein the compound of formula (IA) is selected from the group consisting of 2-ethylhexylacrylate, lauryl(meth)acrylate, lauryl acrylate and stearyl(meth)acrylate.

11. The shaped body according to any of embodiments 1 to 10, wherein the compound of formula (IB) is selected from the group consisting of vinylbutyrate, vinyl-n-hexanoate, vinyl-n-octanoate, vinyl-2-ethylhexanoate, vinyllaurate, vinylstearate, vinylmyristate and vinylpalmitate.

12. The shaped body according to any of embodiments 1 to 11, wherein the compound of formula (IC) is selected from the group consisting of allylbutyrate, allyl-n-hexanoate, allyl-n-octanoate, allyl-2-ethylhexanoate, allyllaurate, allylstearate, allylmyristate and allylpalmitate.

13. The shaped body according to any of embodiments 1 to 12, wherein the melting point of the graft copolymer (I) is in the range of ≥30° C. to ≤120° C.

14. The shaped body according to any of embodiments 1 to 13, wherein the boiling point of the at least one aroma chemical is in the range of ≥50° C. to ≤350° C.

15. The shaped body according to any one of the preceding embodiments, wherein the at least one aroma chemical is present in an encapsulated form.

16. The shaped body according to any of the embodiments 1 to 15, wherein the at least one aroma chemical is present in an amount in the range of ≥0.1% to ≤20.0% wt. %, based on the total weight of the shaped body.

17. The shaped body according to any of embodiments 1 to 16, wherein the at least one aroma chemical is selected from the group consisting of hydrocarbons, aliphatic alcohols, aliphatic aldehydes and acetals thereof, aliphatic ketones and oximes thereof, aliphatic sulfur-containing compounds, aliphatic nitriles, esters of aliphatic carboxylic acids, acyclic terpene alcohols, acyclic terpenes and ketones, cyclic terpene alcohols, cyclic terpene aldehydes and ketones, cyclic alcohols, cycloaliphatic alcohols, cyclic and cycloaliphatic ethers, cyclic and macrocyclic ketones, cycloaliphatic aldehydes, cycloaliphatic ketones, esters of cyclic alcohols, esters of cycloaliphatic alcohols, ester of cycloaliphatic carboxylic acids, araliphatic alcohols, esters of araliphatic alcohols and aliphatic carboxylic acids, araliphatic ethers, aromatic and araliphatic aldehydes, aromatic and araliphatic ketones, aromatic and araliphatic carboxylic acids, nitrogen-containing compounds, phenols, heterocyclic compounds, lactones and essential oils or mixture thereof.

18. The shaped body according to embodiment 17, wherein the essential oil is selected from group consisting of ambra tincture, amyris oil, angelica seed oil, angelica root oil, anise oil, valerian oil, basil oil, tree moss absolute, bay oil, mugwort oil, benzoin resin, bergamot oil, beeswax absolute, birch tar oil, bitter almond oil, savory oil, bucco leaf oil, cabreuva oil, cade oil, calmus oil, camphor oil, cananga oil, cardamom oil, cascarilla oil, cassia oil, cassie absolute, castoreum absolute, cedar leaf oil, cedar wood oil, cistus oil, citronella oil, lemon oil, copaiba balsam, copaiba balsam oil, coriander oil, costus root oil, cumin oil, cypress oil, davana oil, dill oil, dill seed oil, eau de brouts absolute, oakmoss absolute, elemi oil, estragon oil, eucalyptus citriodora oil, eucalyptus oil, fennel oil, spruce needle oil, galbanum oil, galbanum resin, geranium oil, grapefruit oil, guaiac wood oil, gur-jun balsam, gurjun balsam oil, helichrysum absolute, helichrysum oil, ginger oil, iris root absolute, iris root oil, jasmine absolute, calamus oil, camellia oil blue, camellia oil roman, carrot seed oil, cascarilla oil, pine needle oil, spearmint oil, cumin oil, labdanum oil, labdanum absolute, labdanum resin, lavandin absolute, lavandin oil, lavender absolute, lavender oil, lemon grass oil, lovage oil, lime oil distilled, lime oil pressed, linalool oil, litsea cubeba oil, laurel leaf oil, macis oil, marjoram oil, mandarin oil, massoia bark oil, mimosa absolute, musk seed oil, musk tincture, clary sage oil, nutmeg oil, myrrh absolute, myrrh oil, myrtle oil, clove leaf oil, clove flower oil, neroli oil, olibanum absolute, olibanum oil, opopanax oil, orange blossom absolute, orange oil, oregano oil, palmarosa oil, patchouli oil, perilla oil, Peruvian balsam oil, parsley leaf oil, parsley seed oil, petitgrain oil, peppermint oil, pepper oil, allspice oil, pine oil, poley oil, rose absolute, rosewood oil, rose oil, rosemary oil, sage oil dalmatian, sage oil Spanish, sandalwood oil, celery seed oil, spike lavender oil, star anis oil, styrax oil, tagetes oil, fir needle oil, tea tree oil, turpentine oil, thyme oil, tolu bal-sam, tonka absolute, tuberose absolute, vanilla extract, violet leaf absolute, verbena oil, vetiver oil, juniper berry oil, wine yeast oil, vermouth oil, wintergreen oil, ylang oil, ysop oil, civet absolute, cinnamon leaf oil, cinnamon bark oil, and fractions thereof or ingredients isolated therefrom.

19. The shaped body according to any of embodiments 1 to 18, wherein the shaped body has a disk-like, spherical or cuboidal shape.

20. The shaped body according to any of embodiments 1 to 19, the shaped body has rounded corners.

21. The shaped body according any of embodiments 1 to 20, wherein the shaped body has a weight of ≥0.1 mg to ≤5.0 g.

22. The shaped body according to any of embodiments 1 to 21, wherein the shaped body has a weight in the range of ≥5 mg to ≤50 mg.

23. A process for preparing a shaped body according to any of embodiments 1 to 22 comprising at least the steps of
A) melting at least one graft copolymer (I) comprising
i) a polyether and
ii) one or more side chains obtained by the polymerization of compounds of formula (IA) and/or formula (IB) and/or formula (IC);

CH₂═CY—C(═O)—OR₁ formula (IA)

CH₂═CY—O—C(═O)—R₁ formula (IB)

CH₂═CH—CH₂—O—C(═O)—R₁ formula (IC)

wherein R₁ is in each case selected from C₄-C₂₀-alkyl or C₄-C₂₀-alkenyl and Y is in each case selected from hydrogen and methyl,
B) mixing the at least one melted graft copolymer (I) with at least one aroma chemical to obtain a molten mixture of the at least one graft copolymer (I) and the at least one aroma chemical; and
C) forming the molten mixture of the at least one graft copolymer (I) and the at least one aroma chemical into a shaped body.

24. The process according to embodiment 23, wherein the step (C) comprises at least one of the following methods:

dropping and/or spraying the molten mixture of the at least one graft copolymer (I) and the at least one aroma chemical onto a surface or

passing the molten mixture of the at least one graft copolymer (I) and the at least one aroma chemical through small openings or

depositing the molten mixture of the at least one graft copolymer (I) and the at least one aroma chemical into a mold.

25. The process according to embodiment 24, wherein the step (A) comprises heating the at least one graft copolymer (I) to a temperature in the range of ≥30 to ≤120° C.

26. A composition comprising at least one shaped body according to any of embodiments 1 to 22 or obtained by the process according to any of embodiments 20 to 25.

27. The composition according to embodiment 26, wherein the at least one shaped body is present in an amount in the range of ≥0.1% to ≤100% wt. %, based on the total weight of the composition.

28. The composition according to embodiment 26 or 27, wherein the composition is present in the form of solid, liquid, pastes, dispersions or gel.

29. The composition according to any of embodiments 26 to 28, wherein the composition is used as an agent selected from the group consisting of perfumes, washing and cleaning agents, cosmetic agents, body care agents, hygiene articles, food, food supplements and scent dispensers.

30. The composition according to any of embodiments 26 to 28, wherein the composition shows increased aroma retention and aroma longevity.

31. The composition according to any of embodiments 26 to 30, wherein the composition comprises at least one ingredient selected from the group consisting of builders, optical brighteners, bleaches, bleach boosters, bleach catalysts, bleach activators, surfactants, soil release agents, dye transfer agents, dispersants, enzymes, suds suppressers, dyes, colorants, fillers, hydrotropes, enzymes, photoactivators, fluorescers, fabric conditioners, hydrolyzable surfactants, preservatives, anti-oxidants, chelants, stabilizers, anti-shrinkage agents, anti-wrinkle agents, germicides, fungicides, anti-corrosion agents and mixtures thereof.

32. The use of a shaped body according to any of embodiments 1 to 22 or obtained by the process according to any of embodiments 23 to 25 for the controlled release of at least one aroma chemical.

33. A method for controlling the release of at least one aroma chemical, wherein the at least one aroma chemical is comprised by a shaped body according to any of embodiments 1 to 22 or obtained by the process according to any of embodiments 23 to 25.

### EXAMPLES

Analytical Methods:

The number average molecular weight Mₙ is determined by gel permeation chromatography (GPC), with polyethylene glycol as comparison standard. The grafting as such may be con-firmed by HPLC (High Pressure Liquid Chromatography).

The melting point is determined using apparatus M 560, commercially available from Btichi.

### Example 1. Preparation of Polyethylene Glycol-Vinyllaurat Graft Copolymer

A 4-I-vessel with stirrer and three feeds was charged with 2,553 g polyethylene glycol (Pluriol E9000, BASF; Mₙ: 9,000 g/mol) and heated to 90° C. and purged with nitrogen. Solution of radical starter (46 g, tert.-butyl-peroctoate was used as a 25% by weight solution in tripropylene glycol) was fed through feed 1 over a period of 7 hours. After 15 minutes of the commencement of feed 1, an amount of 283.5 g vinyl laurate was fed continuously through feed 2 within 5 hours. After the addition of feed 1 was completed, feed 3 (3 hours, 36 g solution of radical starter) commenced. After the addition of the radical starter had been completed the reaction mixture was stirred at 100° C. for another hour. Then, the pressure was set to 10 mbar, and volatile components were removed at 100° C. and 10 mbar under stirring. The reaction mixture was then cooled to ambient temperature to obtain the graft copolymer as a white solid, 2947 g.

### Example 2

The polyethylene glycol-vinyllaurat graft copolymer (9.0 g; 95 wt. % polyethylene glycol and 5 wt. % vinyllaurat; Mₙ: 9850 g/mol) was melted and mixed with 1.0 g of a mint fragrance (boiling point—207-228° C.) mixture. The molten mixture was dropped onto a cold plate to obtain pellets with a weight of 40 mg.

### Example 3 (Not covered by presently claimed invention)

The polyethylene glycol (Mₙ: 9,000 g/mol, 9.0 g) was melted and mixed with 1.0 g of a mint fragrance mixture. The molten mixture was dropped onto a cold plate to obtain pellets with a weight of 40 mg.

The mint content in Example 2 and Example 3 was determined by gas chromatography be-fore and after storage. The storage temperature was kept at 40° C. and the storage time was 12 weeks for both Example 2 and Example 3. The results were as follows:

| | Example 2 | Example 3 |
|---|---|---|
| Theoretical mint content by | 10 | 10 |
| weight before storage (wt.%) | | |
| Measured mint content by | 9.4 | 9.2 |
| weight before storage (wt.%) | | |
| Measured mint content by | 3.6 | 2.2 |
| weight after storage (wt.%) | | |

The results show an enhanced aroma (mint) retention capability in case of Example 2 (from 9.4 wt. % mint content to 3.6 wt. % mint content). The aroma (mint) retention capability in case of Example 2 is improved by a factor of 1.6 in comparison to Example 3.

Example 4: Procedure for the Preparation of Fillable Spherical Microparticles (Example 7 of WO2019/193094)

The matrix-forming polymer used was a polymer blend of 70% by weight of Polybutylene sebacate terephthalate (PBSeT) and 30% by weight of polycaprolactone. The procedure was as follows:

Pore-forming agent solution: 0.54 kg of ammonium carbonate were dissolved in 53.5 kg of water (pore former). Solution of aliphatic-aromatic polyester: 15.1 kg of PBSeT and 6.5 kg of polycaprolactone were stirred into 270.0 kg of dichloromethane and dissolved at 25° C. with stirring.

To prepare the w/o emulsion, the pore-forming agent solution in the solution of the ali-phatic-aromatic polyester was emulsified for 15 minutes at 170 rpm using a double-stage cross-bar stirrer.

The w/o emulsion thus obtained was converted into 423 kg of a 0.8% by weight aqueous polyvinyl alcohol solution and likewise emulsified with shear and energy input (one minute at 120 rpm with a round anchor stirrer).

The w/o/w emulsion thus produced was then further stirred with an impeller stirrer at 120 rpm, the pressure being reduced to 800 mbar and the jacket temperature slowly heated to 40° C. and kept at this temperature for 4 hours. Thereafter, the microparticle suspension was cooled to room temperature, filtered and dried at 37° C. The average particle diameter D [4,3] determined from the aqueous suspension was 1 10 pm.

### Example 5: Procedure for Preparation of Filled Spherical Microparticles

500 g of the microparticles from Example 4 were placed in a ploughshare mixer and 1000 g solution of the aroma chemical was sprayed at 20° C. by means of a nozzle having a diameter of 0.5 mm (spray pressure 2 bar) within 2 min (flow rate 500 ml/min).

Example 6:

The polyethylene glycol-vinyllaurat graft copolymer (9.0 g; 95 wt. % polyethylene glycol and 5 wt. % vinyllaurat; Mn: 9850 g/mol) was melted and mixed with 0.5 g of the mint fragrance and 0.5 g of spherical microparticles (as described in example 4 and 5 above) filled with mint fragrance (composition: 30 wt. % capsule matrix and 70 wt. % of mint fragrance). The molten mixture was dropped onto a cold plate to obtain pellets with a weight of 40 mg

### Example 7 to 20

The following table depicts the various formulations with the graft polymer incorporating the aroma chemicals with microparticles (as per example 6) and without microparticles (as per example 2)

Polymer: polyethylene glycol-vinyllaurat graft copolymer (95 wt. % polyethylene glycol and 5 wt. % vinyllaurat; Mₙ: 9850 g/mol)

Microparticle composition: 30 wt % capsule matrix and 70% of aroma chemical

Fragrance composition A: Adoxal (1 g), rose oxide 90 (2 g), betadamascone (2 g), D.M.B.C. butyrate (3 g), geranium Egypt oil (5 g), Ambrettolide (10 g), eugenol (10 g), cinnamic alcohol (12 g), petitgrain Paraguay oil (15 g), geranyl acetate extra (15 g), polysantol (20 g), benzyl acetate (20 g), D.M.B.C. acetate (20 g), lyral (35 g), Lysmeral extra (40 g), citronellol (90 g), phenylethyl alcohol (120 g), hedione (150 g), Iso E Super (160 g), Galaxolide 50 (200 g), Methylionone 70 (70 g), dipropyleneglycol (70 g).

| Example | Wt of | | Microparticles/aroma | Weight of |
|---|---|---|---|---|
| no | polymer | Aroma chemical/weight | chemical/Weight | pellets obtained |
| 7 | 9 g | Limonene/1.0 g | — | 45 mg |
| 8 | 9 g | Limonene/0.5 g | 0.5 g microparticles- | 38 mg |
| | | | filled with limonene | |
| 9 | 9 g | Bulgarian rose oil/1.0 g | — | 45 mg |
| 10 | 9 g | Bulgarian rose oil/0.5 g | 0.5 g microparticles- | 40 mg |
| | | | filled with | |
| | | | Bulgarian rose oil | |
| 11 | 9 g | Geraniol/0.5 g | — | 40 mg |
| 12 | 9 g | Geraniol/0.5 g | 0.5 g microparticles- | 50 mg |
| | | | filled with geraniol | |
| 13 | 9 g | Dihydrorosan/1.0 g | — | 40 mg |
| 14 | 9 g | Dihydrorosan/0.5 g | 0.5 g microparticles- | 45 mg |
| | | | filled with dihydrorosan | |
| 15 | 9 g | Litesea cubeba/1.0 g | — | 45 mg |
| 16 | 9 g | Litesea cubeba/0.5 g | 0.5 g microparticles- | 40 mg |
| | | | filled with Litesea cubeba | |
| 17 | 9 g | Nerol/1.0 g | — | 40 mg |
| 18 | 9 g | Nerol/0.5 g | 0.5 g microparticles- | 40 mg |
| | | | filled with Nerol | |
| 19 | 9 g | Fragrance | — | 40 mg |
| | | composition A/1.0 g | | |
| 20 | 9 g | Fragrance | 0.5 g microparticles- | 40 mg |
| | | composition A/0.5 g | filled with fragrance | |
| | | | composition A | |

1. A shaped body comprising
a) at least one graft copolymer (I) comprising
i) a polyether and
ii) one or more side chains obtained by the polymerization of compounds of formula (IA) and/or formula (IB) and/or formula (IC);
CH₂═CY—C(═O)—OR₁ formula (IA)
CH₂═CY—O—C(═O)—R₁ formula (IB)
CH₂═CH—CH₂—O—C(═O)—R₁ formula (IC)
wherein R₁ is in each case selected from C₄-C₂₀-alkyl or C₄-C₂₀-alkenyl and Y is in each case selected from hydrogen and methyl, and
b) at least one aroma chemical.

2. The shaped body according to claim 1, wherein the polyether is selected from the group consisting of polyethylene glycol, polypropylene glycol and ethylene oxide-propylene oxide block copolymer.

3. The shaped body according to claim 1, wherein the graft copolymer (I) has a number average molecular weight Mₙ in the range of ≥2250 to ≤25000 g/mol.

4. The shaped body according to claim 1, wherein the graft copolymer (I) is present in an amount in the range of ≥80.0% to ≤99.9% wt. %, based on the total weight of the shaped body.

5. The shaped body according to claim 1, wherein R₁ is selected from the group consisting of n-hexyl, isohexyl, sec-hexyl, n-heptyl, n-octyl, 2-ethylhexyl, n-nonyl, n-decyl or isodecyl, n-dodecyl, n-C₁₂H₂₅, n-C₁₄H₂₉, n-C₁₆H₃₃, n-C₁₈H₃₇, n-hexenyl, isohexenyl, n-heptenyl, n-octenyl, n-decenyl and n-dodecenyl.

6. The shaped body according to claim 1, wherein the compound of formula (IA) is selected from the group consisting of 2-ethylhexyl(meth)acrylate, 2-n-propylheptyl(meth)acrylate, stearyl(meth)acrylate, lauryl(meth)acrylate, lauryl acrylate, palmityl(meth)acrylate and myristyl(meth)acrylate.

7. The shaped body according to claim 1, wherein the compound of formula (IA) is selected from the group consisting of 2-ethylhexylacrylate, lauryl(meth)acrylate, lauryl acrylate and stearyl(meth)acrylate.

8. The shaped body according to claim 1, wherein the compound of formula (IB) is selected from the group consisting of vinylbutyrate, vinyl-n-hexanoate, vinyl-n-octanoate, vinyl-2-ethylhexanoate, vinyllaurate, vinylstearate, vinylmyristate and vinylpalmitate.

9. The shaped body according to claim 1, wherein the compound of formula (IC) is selected from the group consisting of allylbutyrate, allyl-n-hexanoate, allyl-n-octanoate, allyl-2-ethylhexanoate, allyllaurate, allylstearate, allylmyristate and allylpalmitate.

10. The shaped body according to claim 1, wherein the at least one aroma chemical is present in an amount in the range of ≥0.1% to ≤20.0% wt. %, based on the total weight of the shaped body.

11. The shaped body according to claim 1, wherein the at least one aroma chemical is selected from the group consisting of hydrocarbons, aliphatic alcohols, aliphatic aldehydes and acetals thereof, aliphatic ketones and oximes thereof, aliphatic sulfur-containing compounds, aliphatic nitriles, esters of aliphatic carboxylic acids, acyclic terpene alcohols, acyclic terpenes and ketones, cyclic terpene alcohols, cyclic terpene aldehydes and ketones, cyclic alcohols, cycloaliphatic alcohols, cyclic and cycloaliphatic ethers, cyclic and macrocyclic ketones, cycloaliphatic aldehydes, cycloaliphatic ketones, esters of cyclic alcohols, esters of cycloaliphatic alcohols, ester of cycloaliphatic carboxylic acids, araliphatic alcohols, esters of araliphatic alcohols and aliphatic carboxylic acids, araliphatic ethers, aromatic and araliphatic aldehydes, aromatic and araliphatic ketones, aromatic and araliphatic carboxylic acids, nitrogen-containing compounds, phenols, heterocyclic compounds, lactones and essential oil or mixture thereof.

12. The shaped body according claim 1, wherein the shaped body has a weight of ≥0.1 mg to ≤5.0 g.

13. A process for preparing the shaped body according to claim 1
comprising at least the steps of
A) melting at least one graft copolymer (I) comprising
a) a polyether and
b) one or more side chains obtained by the polymerization of compounds of formula (IA) and/or formula (IB) and/or formula (IC);
CH₂═CY—C(═O)—OR₁ formula (IA)
CH₂═CY—O—C(═O)—R₁ formula (IB)
CH₂═CH—CH₂—O—C(═O)—R₁ formula (IC)
wherein R₁ is in each case selected from C₄-C₂₀-alkyl or C₄-C₂₀-alkenyl and Y is in each case selected from hydrogen and methyl,
B) mixing the at least one melted graft copolymer (I) with at least one aroma chemical to obtain a molten mixture of the at least one graft copolymer (I) and the at least one aroma chemical; and
C) forming the molten mixture of the at least one graft copolymer (I) and the at least one aroma chemical into a shaped body.

14. A composition comprising at least one shaped body according to claim 1.

15. The composition according to claim 14, wherein the composition shows increased aroma retention and aroma longevity.

16. A method for controlling the release of at least one aroma chemical comprising: using the shaped body according to claim 1.
